(19) United States
(12) Patent Application Publication
(10) Pub. No.: US 2011/0120039 A1
(43) Pub. Date: May 26, 2011

(54) HIGH STRENGTH COMPOSITE FRAMING MEMBERS

(75) Inventor: FRED L. MINELLI, Carrollton, TX (US)

(73) Assignee: KYSOR PANEL SYSTEMS, DIVISION OF WELBILT WALK-INS LP

(21) Appl. No.: 12/949,770

(22) Filed: Nov. 18, 2010

Related U.S. Application Data
(60) Provisional application No. 61/264,121, filed on Nov. 24, 2009.

(51) Int. Cl. E04C 1/40; B29C 67/20

(52) U.S. Cl. 52/309.7; 264/46.7

(57) ABSTRACT

A reinforced framing member is comprised of a low density polymer base and a reinforcing member disposed within the base. The reinforcing member can be a metal, wood or a high density polymer. The low density polymer base that is reinforced can have a density of from about 6 to about to about 20 lbs. per cu. foot. The reinforcing member can have a density of from about 30 to about 90 lbs. per cu. foot.

### RELATED APPLICATIONS

This non-provisional U.S. patent application is related to and claims the benefit of U.S. provisional application Ser. No. 61/264,121 filed Nov. 24, 2009.

### BACKGROUND

1. Field of the Disclosure

This disclosure relates to composite framing members for use on insulated panels. More particularly, the disclosure relates to high strength composite rails or framing members for use on insulated panels for modular and other structures such as walk-in coolers, freezers and non-refrigerated enclosures.

2. Description of the Related Art

For many years wood has been considered the structural material of choice for making rails, often referred to as framing members, in terms of providing strength, structural resistance, resistance to abuse, and capacity, e.g., regarding design loads for roof and wall members. Recently, the direction of the framing member industry has been away from wood based framing members toward metal, and more recently, toward plastic or polymeric material based rails or framing members.

Metal rails or framing members have been found unsuitable because they do not prevent, and typically they increase thermal transfer, e.g., from interior to exterior surfaces of the rail or framing member. U.S. patent application, Ser. No. 11/007,865, filed on Dec. 9, 2004, discloses framing members having a fire rated resilient skin for urethane insulated panels. Such framing members are advantageous because they are devoid of metal and therefore have eliminated thermal transfer, and they have R values greater than those of wood framing members.

However, it has been discovered that these framing members have at times been found to have several shortcomings. The primary disadvantage has been in terms of lacking sufficient structural capacity or strength, for example, to resist flexing and bowing during or after their formation by a low density urethane foam injection or pouring process. Further, at times the quality of these low density framing members is lacking in terms of inconsistency of size and difficulty in meeting specified dimensions. Yet further, at times during and/or as a result of their assembly one to another or to insulated panels, these low density urethane or other low density framing members may be found to be lacking the capability or functionality of being able to resist compression and not being able to mount and hold and not be damaged by connecting and fastening housings and devices such as metal cam locks. Generally, it has been found difficult to overcome or improve these shortcomings sufficiently without significantly increasing the cost, size or density of the low density material of the framing members.

Accordingly, the present disclosure overcomes the deficiencies of conventional framing members by providing a plastic, preferably an all-plastic, rail or framing member that has greater structural capacity or strength than wood framing members, and that has sufficient strength to resist bowing and flexing upon and after exiting the mold, without increasing or significantly increasing the cost or size of the plastic or all-plastic framing member. One approach is to increase the amount of low density plastic in or of the framing member. Sufficiently increasing the amount of the low density plastic results in increased size of the framing member. Increasing the amount of low density material also is too costly. Available options are wood framing members or metal ones. It was expected that the strength or weight of a plastic or all-plastic framing member could not be increased to being greater than that of a wood framing member, without the cost being prohibitive. However, the present inventor has unexpectedly discovered that the strength of a plastic or all-plastic framing member can be made to be stronger, for example, by from 10 to 15 percent compared to that of the strength of a wood framing member, without a substantial difference in the cost of materials. It has also been unexpectedly discovered by the present inventor that by adding a small amount of a reinforcing member, material or portion (hereinafter, “a reinforcing member” includes a reinforcing material or reinforcing portion) for example, a high density plastic member can add the needed strength to a plastic or all-plastic framing member, such that the weight of the reinforced framing member is lighter than, and its strength is greater than, that of a wood framing member, without increasing the density of the low density plastic material of the low density framing member, or the size or dimensions of the reinforced plastic or all-plastic framing member, and this can be accomplished without a materially significant increase in material cost.

The present disclosure provides rails or framing members and methods of making them that overcome one or more of the above-mentioned and other problems and/or shortcomings.

The present disclosure also provides many additional advantages, which shall become apparent as described below.

### SUMMARY

A rail or framing member comprising a low density polymer base and a metal, wood or high density polymer reinforcing member disposed within a portion of the low density polymer base, thereby increasing structural integrity of the resultant framing member. The low density polymer material can be a urethane, preferably a foamed urethane. The increased structural values include increased strength, and increased thermal resistance and structural capacity.

A low density polymeric foam framing member has increased strength, quality and/or functionality.

A low density polymeric foam framing member has one or more of the benefits mentioned herein without increasing the size, amount or density of the low density material.

A low density framing member has increased strength so that it can resist flexing and bowing during and after its formation.

A low density framing member that is consistent in size and dimensions.

A low density framing member that has the capability or functionality of being able to resist compression and mount and hold and not be damaged by connection and fastening housings and devices such as metal cam locks.

A low density framing member that exhibits one or more of the above-mentioned or other improved properties obtained by adding to the low density base material of the framing member at least one reinforcing member having a density greater than that of the low density base material of the framing member.

A reinforced low density framing member wherein the low density base material that is reinforced can be any suitable material having a low density of from about 6 to about 20 lbs. per cu. foot.

A reinforced low density framing member, wherein the reinforcing member has a high density of from about 30 to about 90 lbs. per cu. foot.

A reinforced low density framing member, wherein the low density base material that is reinforced can be comprised of a plastic, polyethylene, urethane, polyvinyl chloride or polystyrene.

A reinforced low density framing member, wherein the low density base material that is reinforced is comprised of a foamed or non-foamed urethane material.

A reinforced low density framing member, wherein the reinforcing high density member, material or portion can be comprised of a metal, wood, plastic, fiber-reinforced plastic, polyvinyl chloride, blend, composite, or any combination of any of the same.

k reinforced low density framing member, wherein the reinforcing high density material is foamed, insulating, and/or thermal resistant.

A reinforced low density framing member, wherein the reinforcing high density material is comprised of a foamed or non-foamed urethane material.

A reinforced low density framing member, wherein the high density reinforcing structure, material or portion can be comprised of metal, wood, plastic, fiber reinforced plastic, polyvinyl chloride, composite, cold polymer alloy and any combination of any of the same materials that preferably are foamed, insulating, and/or thermally resistant.

A reinforced low density framing member, wherein the low density framing member composite is constructed of materials that are Class 1 fire retardant, and that have high strength and low thermal conductivity.

A method of forming a reinforced low density framing member, wherein the method comprises providing in a mold cavity a heated pool or portion of low density base material having a density of from about 6 to about 20 lbs. per cu. foot, depositing a high density reinforcing member, material or portion onto the heated pool of low density material, pressing the reinforcing member, material or portion into the low density base material to form a low density—high density composite or hybrid, allowing the composite to cool, and removing the composite from the mold, wherein the steps are not necessarily effected in the order given.

Further objects, features and advantages of the present disclosure will be understood by reference to the following drawings and detailed description.

### BRIEF DESCRIPTION OF THE DRAWINGS

FIG. 1 is a front perspective view of a first embodiment of a molded high density-reinforced, grooved low density base framing member;

FIGS. 2 through 2D are vertical cross sectional views showing steps of a method of forming the molded high density-reinforced, grooved low density base framing member of FIG. 1; FIG. 2 shows a high density pre-form suspended above a mold containing heated low density base material;

FIG. 2A shows the high density reinforcing pre-form of FIG. 2 after it has been deposited onto the heated low density base material in the mold of FIG. 2:

FIG. 2 B shows the mold cover closed down onto the top of the pre-form of FIG. 2A, after the cover has been pressed down to press the pre-form into the low density base material;

FIG. 2C shows the mold cover of FIG. 2B being lifted to open the mold after the upper surface of the pre-form is level with the side upper surface of the low density base material;

FIG. 2D shows the finished reinforced grooved product removed from the mold;

FIG. 3 shows a finished reinforced tongue product formed by basically the same steps as disclosed for FIGS. 2 through 2D, except that the mold of FIGS. 2 through 2D is shaped to form the tongued product of FIG. 3;

FIG. 4 is a schematic front elevational view of the combination of the reinforced grooved product of FIG. 2D, elevated over and vertically aligned with the underlying inverted reinforced tongue product of FIG. 3;

FIG. 5 is a front elevated perspective view of side-by-side elongated portions of reinforced tongue and groove products such as schematically shown in FIG. 4;

FIG. 6 is a schematic vertical sectional view of another embodiment of a reinforcing member of the disclosure;

FIG. 6A is a schematic vertical sectional view of the reinforcing member embodiment of FIG. 6, here shown reinforcing respective grooved and tongued low density base members, similar to those of FIG. 4;

FIG. 7 is a schematic vertical sectional view of another embodiment of the reinforcing member of the disclosure; and

FIG. 7A is a schematic vertical sectional view of the reinforcing member embodiment of FIG. 7, here shown reinforcing respective grooved and tongued low density base members, similar to those of FIG. 4; and

FIG. 8 is a schematic vertical sectional view through vertically aligned reinforced tongue and groove products having conventional interior and exterior metal panels or skins, prior to assembly of the reinforced tongue and groove products.

### DETAILED DESCRIPTION OF PREFERRED EMBODIMENTS

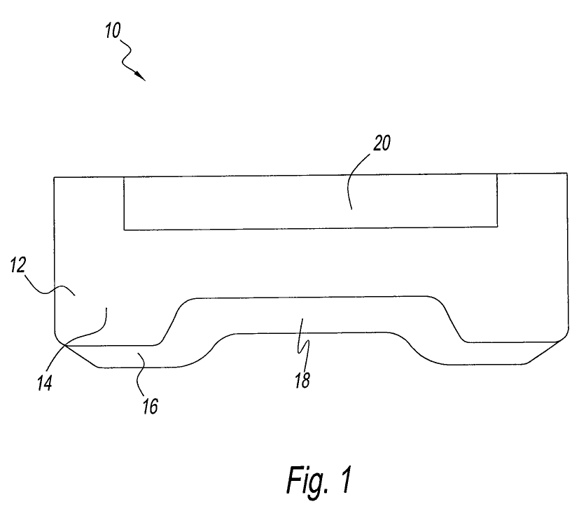

Referring to the drawings in detail, there is shown in FIG. 1 a front perspective view of a preferred embodiment of a molded high density-reinforced, grooved low density rail or base framing member. More particularly, FIG. 1 shows a framing member 10 comprised of a base member 12 of low density plastic material 14, preferably, a low density foamed urethane, having in its bottom surface 16 a groove 18. Base member 12 is reinforced by a reinforcing member, material or portion 20 that has a density greater than the density of low density base material 14. The density of low density base material 14 can be from 6 to about 20 lbs. per cu. foot, preferably below 15 lbs. per cu. foot, more preferably from about 8 to about 12 lbs. per cu. foot, and most preferably about 10 lbs. per cu. foot. If the density of the low density material is too high, the cost increases and additional reinforcing may not be required. If the density of the low density is too low, it becomes too weak to be used without reinforcing. The low density material that is reinforced can be comprised of a plastic, for example, a polyethylene, urethane, polyvinyl chloride, polystyrene, or any combination of any of the same. The most preferred low density materials are foamed or, less preferably, non-foamed urethane, and polyvinyl chloride. A suitable commercial low density material is sold by BASF under the trade name “Elastopor” resin. It has a density of about 10 lbs. per cu. foot. Another suitable low density material is sold by DOW under the trade name “Voracore” resin. It may be desirable to reduce the density of some of the low density material of the low density frame member, and to make up for it by adding more high density reinforcing material.

Reinforcing member 20 can be comprised of any suitable member, material or portion, for example, a metal, wood, plastic, fiber-reinforced plastic, polyvinyl chloride, blend, composite, or any other combination of any of the same. Reinforcing member 20 has a high density that is higher than the density of the low density base material of the framing member. The density of the high density material can be in the range of from about 30 to about 90 lbs. per cu. foot, preferably from about 40 to about 80 lbs. per cu. foot, and most preferably about 60 lbs. per cu. foot. If the density of the high density reinforcing material is too high, the framing member is stronger, but the cost is too high. If the density of the reinforcing member or material is too low, there is not enough support to improve the strength of the framing member. The reinforcing member, material or portion preferably is foamed, and is insulating, and/or thermal resistant. The reinforcing high density material preferably is comprised of a foamed or, less preferably, non-foamed, urethane material. A suitable commercial reinforcing high density material is a high density polyethylene sold under the trade name “SINTRA”. It has a density of about 40 lbs per cu. foot. Another suitable commercial material is a polyvinyl chloride sold under the trade name “KOMATEX”. It has a density of about 60 lbs. per cu. foot. A reinforced low density rail or framing member has been constructed in accordance with the disclosure using a low density urethane having a density of 10 lbs. per cu. foot, reinforced with a high density urethane having a density of about 60 lbs. per cu. foot.

Aluminum or steel can be used as the material of the reinforcing member, preferably so long as the amount or breadth of metal is narrow enough to prevent or avoid thermal transfer. The preferred reinforcing member or material is a member or material that is reinforcing, is a Class 1 fire retardant, and is high strength, and/or very low in thermal conductivity.

It is contemplated that the reinforcing member can be wood including, for example, plywood, engineered wood, oriented strand board or laminated veneer lumber.

It is also contemplated that a mixture or blend of high density urethane and low density urethane can be employed. The materials can be simultaneously poured, or two injectors could be used, one injecting the low density urethane and the other injecting the high density urethane while the first material is still being injected. It is preferred that each of the low density and the high density materials be two-part materials that expand or foam by chemical reactions upon being injected.

The reinforced low density framing members of the disclosure that comprise low density plastic reinforced with a reinforcing member, e.g., a high density plastic member or material, are stronger and lighter than wood framing members and they have higher R values (better insulating properties) than wood framing members. The R value for a non-wood, low density plastic, plastic reinforced framing member according to the disclosure is R-4.25 per inch, while the R-value of a wood framing member is about 1.25 per inch.

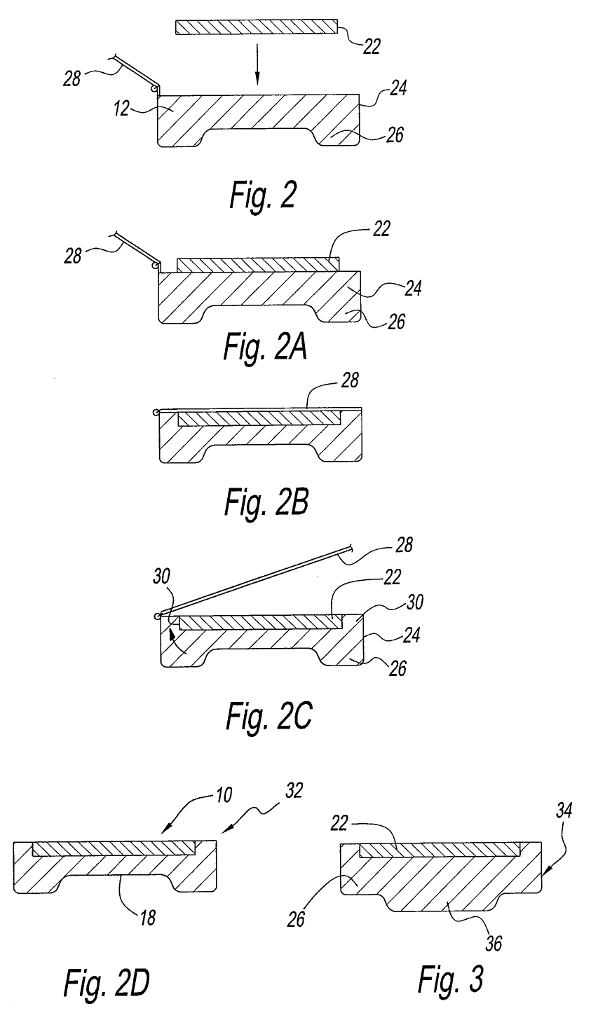

FIGS. 2 through 2D are vertical cross sectional views showing steps of a preferred method of forming, preferably, molding, the molded high density-reinforced, grooved low density rail or base framing member 10.

FIG. 2 shows a high density pre-form 22 suspended or elevated above a mold 24 containing a pool or mass of heated low density base material 26. Pre-form 22 can be formed by any suitable method, for example, molding. The low density base material 26 has a density of from about 6 to 20 lbs per cu. foot.

FIG. 2A shows high density pre-form 22 after it has been deposited onto the upper surface of heated low density base material 26 in mold 24. This method of reinforcing a framing member is easy to execute. It also permits easy reinforcement by adding pre-forms of a variety of different shapes, sizes, materials and strengths. This facilitates providing non-wood framing members that are structurally stronger than wooden framing members. For heavier strength requirements, metal pre-forms can be employed.

FIG. 2B shows mold cover 28 closed down onto the top of pre-form 22 of FIG. 2A, after the cover has been pressed down to press the pre-form into low density base material 26.

FIG. 2C shows mold cover 28 of FIG. 2B being lifted to open mold 24, preferably after the upper surface of the pre-form is level with the side upper surfaces of the low density base material 26, to either side, preferably, i.e., both sides or edges 30 of pre-form 22. It is desirable to have side edges 30 of low density material to vent trapped air (see arrows) from low density base material 26 in mold 24. Preferably, edges of at least about ⅛ inch width are desired on each side of pre-form 22 to vent air from the low density material.

FIG. 2D shows finished, molded high density reinforced grooved low density base framing member 10 after it has been removed from mold 24, after framing member 10 has had a small portion of its end edge trimmed to provide a smooth finish to the end of frame member 10. Other methods of providing or forming reinforcing members 20 include extrusion and injection molding.

FIG. 3 shows a finished, molded high density reinforced tongue product 34 having a tongue 36, the product 34 being formed by basically the same steps as disclosed for FIGS. 2 through 2D, except that the mold 24 of FIGS. 2 through 2D is shaped to form the tongued product 34 of FIG. 3.

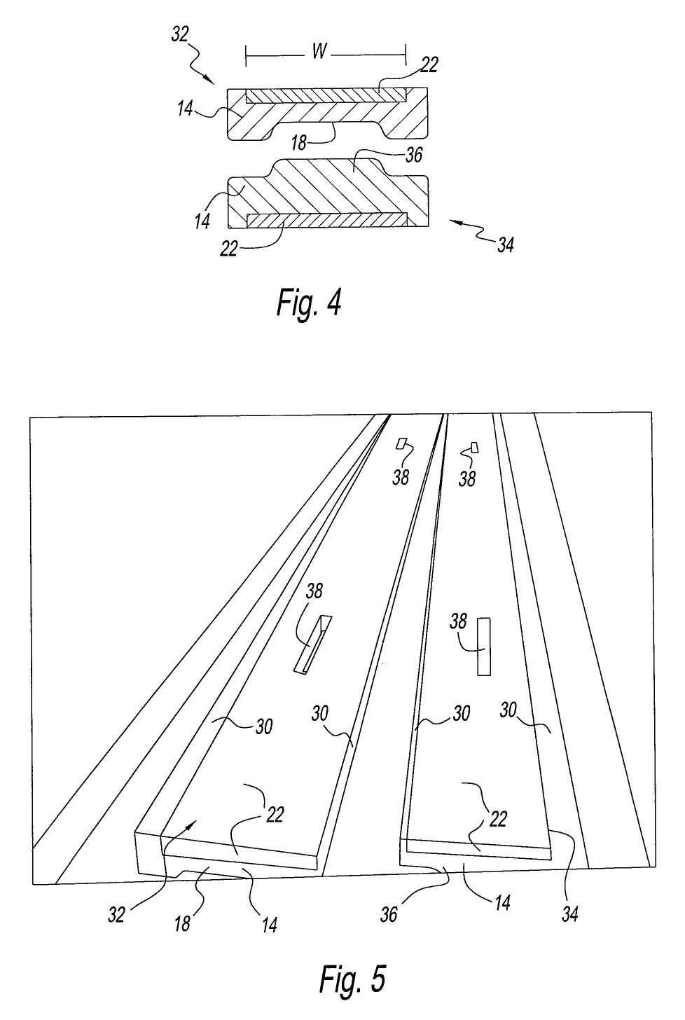

FIG. 4 is a schematic front elevational view of the combination of the reinforced grooved product 32 of FIG. 2D, elevated over and vertically aligned with the underlying inverted reinforced tongue product 34 of FIG. 3.

The width W and the thickness T of pre-form 22 can and will vary depending on the uses and designed strength and reinforcement requirements of reinforcing member 20 and of finished tongue product 34 and of finished grooved product 32.

FIG. 5 is a photo showing a front elevated perspective view of side-by-side elongated portions of a finished reinforced tongue product 34 and a finished reinforced groove product 32. FIG. 5 also shows each product 32, 34 having longitudinally and side-by-side aligned through slots 38 for receiving conventional cam locks (not shown) for attaching finished tongue and groove products 34, 32 to each other.

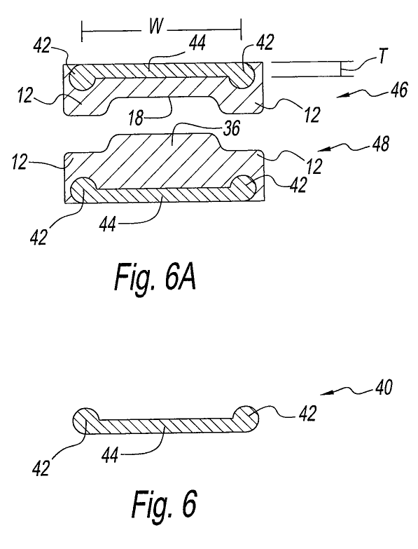

FIG. 6 is a schematic vertical sectional view through another embodiment of a reinforcing member or material 40 of the disclosure prior to the member being joined to low density base member 12. More particularly, FIG. 6 shows a vertical section through a barbell-shaped reinforcing member 40, the member having circular bells or rods 42 at opposite ends of an intermediate bar or plate 44. Barbell-shaped reinforcing member 40 can be comprised of any suitable high density material including a metal, for example aluminum or steel, so long as the metal is narrow and completely encapsulated to ensure that thermal transfer is contained.

FIG. 6A is similar to FIG. 4 in that it is a schematic front elevational view of the combination of reinforced grooved product 46 elevated over and vertically aligned with the underlying inverted reinforced tongue product 48. Reinforced grooved product 46 and reinforced tongue product 48 can respectively be formed by the method disclosed in FIGS. 2 through 2D.

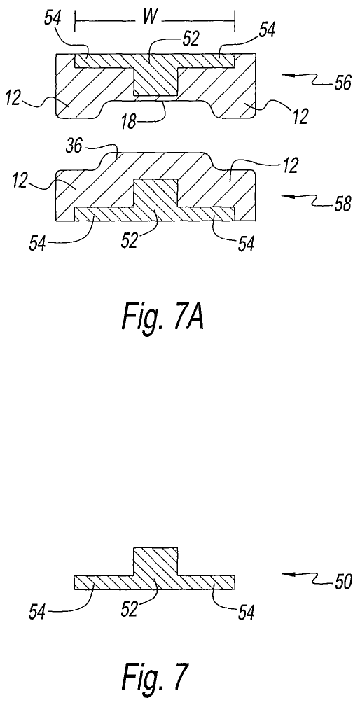

FIG. 7 is a schematic vertical sectional view through another embodiment of a reinforcing member or material 50 of the disclosure prior to member 50 being joined to low density base member 12. More particularly, FIG. 7 shows a vertical section through an inverted T-shaped reinforcing member 50, the member having a wide central vertical base 52 joined to the center of the width of a planar elongated top plate 54. T-shaped reinforcing member 50 can be comprised of any suitable high density material including a metal, for example aluminum or steel, so long as the metal is narrow and completely encapsulated or otherwise adapted to ensure that thermal transfer is contained.

FIG. 7A is similar to FIG. 6A in that it is a schematic front elevational view of the combination of reinforced grooved product 56 elevated over and vertically aligned with the underlying inverted reinforced tongue product 58. Reinforced grooved product 56 and reinforced tongue product 58 can respectively be formed by the method disclosed in FIGS. 2 through 2D.

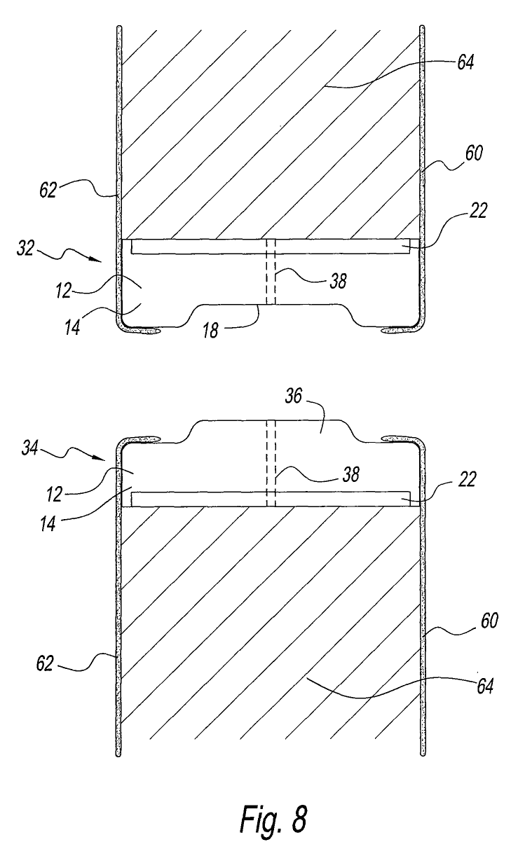

FIG. 8 is a schematic vertical sectional view through a vertically aligned reinforced tongue product 34 and a reinforced groove product 32 having conventional interior metal panels or skins 60 and exterior metal panels or skins 62 prior to assembly of reinforced tongue and groove products 34 and 32 together. Panels 60 and 62 protect the central urethane foam core and the edges of the low density plastic material 14 from damage. FIG. 8 also shows that the vertical sections in FIG. 8 are taken orthogonal to and through the longitudinal axis and through slots 38 (dashed lines). Slots 38 receive housings of cam locks (not shown), one housing in the tongue side that has a protruding male hook that engages and locks onto a horizontal pin on the grooved side. The cam lock compresses the low density foam while the high density foam resists compression to provide a desirable tight and functional lock of the tongue and groove framing members.

This disclosure provides two versions of framing members, a tongue and groove version, and an advantageous, plain, non-tongue and groove board version. In the plain board version, a high density reinforcing member, which can be a pre-form, is deposited onto a pool of heated low density material, as in the preferred method, so that the high density reinforcing member or material is up against and protected by the outer, upper edge of the low density material. It is believed that the low and high density materials are joined by chemical bonding.

Briefly, in the application of preferred embodiments of the disclosure, tongue and groove frame members 10 would be molded, cut to length preferably at ambient temperatures and trimmed to remove rough edges and irregular surfaces at each end of the framing member. Slots 38 are formed, the housings of cam lock fasteners are mounted in the slots, and perimeter frames are built using the tongue or groove frame members to frame and join three-layer panels comprised of an interior metal sheet, and an exterior metal sheet, one to either side of a panel of poured urethane foam core insulation 64. A three layer panel is perimetally framed with, for example, a reinforced tongue framing member of the disclosure and is joined by the tongue framing member to another three layer panel that is perimetally framed with a reinforced groove framing member, the joint being formed by the juncture of the tongue and the groove and by the action of the cam lock fastener.

The framing members or rails of the disclosure are used for perimeter frames for metal or wood covered insulated panels, for refrigerated rooms, storage rooms, walk-in coolers and freezers, equipment enclosures, buildings, houses, etc. By use of the disclosed invention, stronger framing or rail members can be made, without changing its overall shape, size or specified dimensions. Adding the high density reinforcement preserves the shape and integrity and specified dimensions of the high density reinforcing member or material. Adding the high density reinforcement member, material of portion to the mold increases the strength of the upper edge or sidewall of the low density base member. With respect to reinforcing frame members with a metal, the type of material, e.g., steel, density, properties and specifications will depend on the product design, use and strength specifications. The preferred steel is stainless and would have a density of about 500 lbs. per cu. foot, and its yield strength can be 50 ksi or 36 ksi. The steel preferably is encapsulated in low density framing member material to prevent thermal transfer.

While I have shown and described several embodiments in accordance with my invention, it is to be clearly understood that the same may be susceptible to numerous changes apparent to one skilled in the art. Therefore, I do not wish to be limited to the details shown and described but intend to show all changes and modifications that come within the scope of this disclosure.

I claim:

1. A reinforced framing member comprised of a low density polymer base, and a reinforcing member disposed within a portion of the base, wherein the reinforcing member can be a metal, wood or a high density polymer, and the reinforcing member increases the structural strength of the framing member.

2. The reinforced framing member of claim 1, wherein the low density polymer base is a non-foamed or foamed urethane and the reinforcing member is a high density polymer.

3. The reinforced framing member of claim 2, wherein the low density polymer base that is reinforced can be any suitable material having a low density of from about 6 to about to about 20 lbs. per cu. foot.

4. The reinforced framing member of claim 3, wherein the reinforcing member is a high density polymer that has a density of from about 30 to about 90 lbs. per cu. foot.

5. The reinforced framing member of claim 1, wherein the low density polymer base is at least one polymer selected from the group consisting of: plastic, polyethylene, urethane, polyvinyl chloride and polystyrene.

6. The reinforced low density framing member of claim 1, wherein the reinforcing high density material is at least one material selected from the group consisting of: a plastic, composite, fiber-reinforced plastic, polyvinyl chloride, blend, cold polymer alloy and any combination thereof.

7. The reinforced framing member of claim 1, wherein each of the low density polymer base and the high density polymer reinforcing member disposed within the low density polymer base is comprised of a foamed urethane, wherein the reinforced framing member (a) has sufficient structural strength to resist flexing and bowing during and after its formation, (b) is consistent in size and able to meet specified dimensions, and (c) resists the compressive forces of applied metal cam locks.

8. A method of forming a reinforced low density framing member, wherein the method comprises providing in a mold cavity a heated pool or portion of low density polymer base material, depositing a high density reinforcing member onto the heated pool of said low density base material, pressing the reinforcing member material into the low density base material to form a low density-high density composite, allowing the composite to cool, and removing the composite from the mold.

9. The method of claim 8, wherein the low density polymer base material has a density of from about 6 to about 20 lbs. per cu. foot, and the high density reinforcing member has a density of about 30 to about 90 lbs. per cu. foot

10. The method of claim 8, wherein the low density polymer base material is a non-foamed or foamed urethane, and the high density reinforcing material is at least one material selected from the group consisting of: metal, wood and a high density polymer.

11. A molded reinforced all-plastic framing member that is formed with heat and a mold and that is comprised of a) a low density polymer base material, and b) a high density polymer reinforcing member that is disposed within a portion of the low density polymer base material, wherein the molded reinforced all-plastic framing member is a) lighter than, yet has greater structural capacity and strength than wood framing members, and b) has sufficient strength to resist bowing and flexing upon exiting the mold.

12. The molded reinforced all-plastic framing member of claim 11, wherein the low density polymer base material is a foamed urethane, and the high density polymer reinforcing member also is a foamed urethane.
